(19) United States
(12) Patent Application Publication
(10) Pub. No.: US 2011/0222877 A1
(43) Pub. Date: Sep. 15, 2011

(54) DIRECT PRINTING METHOD AND IMAGE FORMING DEVICE FOR PERFORMING THE SAME

(75) Inventor: Seong-Taek Lim, Suwon-si (KR)

(73) Assignee: SAMSUNG ELECTRONICS CO., LTD., Suwon-si (KR)

(21) Appl. No.: 13/130,386

(22) PCT Filed: Nov. 17, 2009
(86) PCT No.: PCT/KR09/05693

§ 371 Date: May 20, 2011

(30) Foreign Application Priority Data
Nov. 21, 2008 (KR) 10-2008-0116411

(51) Int. Cl. G03G 15/00

(52) U.S. Cl. 399/38

(57) ABSTRACT

A direct printing method and an image forming device for performing the direct printing method are provided. The image forming device includes an image forming body and a controller. The image forming body includes a plurality of electrodes, and the controller controls to operate at least some of the plurality of electrodes at different times and print a single line image.

### TECHNICAL FIELD

### Technical Field

One or more embodiments relate to a direct printing method and an image forming device for performing the direct printing method.

### BACKGROUND ART

### Background Art

Electrophotographic image forming devices form an image by forming an electrostatic latent image on the surface of a photosensitive drum and developing the electrostatic latent image by using a developer, such as a toner, to transfer and fix the image onto a printing medium.

Electrophotographic image forming devices form the electrostatic latent image on the surface of the photosensitive drum by uniformly electrifying the surface of the photosensitive drum and allowing the surface of the photosensitive drum to be exposed according to data of an image that is to be formed.

Meanwhile, direct printing type image forming devices for directly forming an image on the surface of an image forming body without an electrifying device and a light scanning device have been suggested.

### DISCLOSURE OF INVENTION

### Technical Problem

Direct printing type image forming devices include a plurality of ring electrodes that simultaneously operate when a single line is printed. In this case, an instant current value greatly increases, which reduces a power voltage and adversely affects the reliability of a driving circuit.

### Technical Solution

One or more embodiments include a direct printing method of reducing an instant maximum current value by using an image forming body having a plurality of ring electrodes and an image forming device for performing the direct printing method.

Additional aspects will be set forth in part in the description which follows and, in part, will be apparent from the description, or may be learned by practice of the presented embodiments.

To achieve the above and/or other aspects, one or more embodiments may include a printing method that uses an image forming body including a plurality of electrodes, wherein at least one of the plurality of electrodes is operated with regard to an adjacent electrode at different times.

To achieve the above and/or other aspects, one or more embodiments may include a printing method that uses an image forming body including a plurality of electrodes, wherein an image of a single line is printed by operating at least some of the plurality of electrodes at different times.

Each of the plurality of electrodes may be operated at different times.

The plurality of electrodes may be grouped into at least one group and each group of the plurality of electrodes may operate at different times.

The plurality of electrodes may be ring electrodes.

The printing method may include: calculating image density of each line from data of the image that is to be printed; determining whether each of the plurality of electrodes is operated or the plurality of electrodes are grouped into at least one group according to the calculated image density in each line; and printing the image of each line by operating each of the plurality of electrodes or each group of the plurality of electrodes at different times.

If it is determined that the plurality of electrodes are grouped into at least one group, the more the image density increases, the more the number of groups increases.

If it is determined that the plurality of electrodes are grouped into at least one group, the plurality of electrodes included in the same group may be simultaneously operated.

If it is determined that the plurality of electrodes are grouped into a plurality of groups, the plurality of groups may be sequentially numbered from one side of the plurality of electrodes, and, when it is determined that the plurality of electrodes are grouped into n groups, an m^{th} group may include m^{th}, n+m^{th}, 2n+m^{th}, . . . electrodes.

When it is determined that the plurality of electrodes are grouped into n groups, the n groups may be sequentially operated at predetermined different times.

The image may be formed in a printing pattern including a plurality of oblique lines each including n dots along printing lines.

When it is determined that the plurality of electrodes are grouped into n groups, the n groups may be divided into a former group and a latter group and may be alternately operated at predetermined different times.

The image may be formed in a printing pattern including a plurality of oblique lines each including n/2 dots along printing lines.

When it is determined that the plurality of electrodes are grouped into n representative groups, groups included in the first representative group and groups included in the third representative group may alternately operate and then groups included in the second representative group and groups included in the fourth representative group may alternately operate.

The groups included in the second representative group and the groups included in the fourth representative group may alternately operate in a reverse order.

The image may be formed in a printing pattern including a plurality of zigzag oblique lines each including n/4 dots along printing lines.

When it is determined that the plurality of electrodes are grouped into a plurality of groups, the plurality of groups may be sequentially numbered from one side of the plurality of electrodes and one of each groups may be selectively operated.

The electrode having the same number of each group may be selectively operated.

The calculating and the determining my be performed by a central processing unit (CPU) of an image forming device and the operating of the plurality of electrodes may be performed by a driver chip formed in the image forming body.

Group designation information generated by the CPU of the image forming device may be 8 bit serial control data, be transmitted to the driver chip, and be stored in a first register of the driver chip.

The 8 bit serial control data may include information about the number of clock delays corresponding to a determined time difference, and the information about the number of clock delays may be stored in a second register of the driver chip.

To achieve the above and/or other aspects, one or more embodiments may include an image forming device including: an image forming body including a plurality of electrodes; and a controller controlling to operate at least some of the plurality of electrodes at different times and print a single line image.

The controller may include: a memory storing the image that is to be printed; a CPU calculating image density of each line from data of the image that is to be printed, determining whether each of the plurality of electrodes is operated or the plurality of electrodes are grouped into at least one group according to the calculated image density of each line, and generating control data including group designation information of each line and an image signal; and a driver chip operating each of the plurality of electrodes or the each group of the plurality of electrodes at different times according to the control data and the image signal received from the CPU.

An electrode control board may be installed in a drum body of the image forming body, and wherein the electrode control board includes the driver chip and a circuit coupling the driver chip to each of the plurality of electrodes.

The control data may be 8 bit serial control data that be transmitted from the CPU to the driver chip.

The driver chip may include a first register storing the group designation information of each line.

The control data may further include information about the number of clock delays corresponding to a determined time difference, and the driver chip further includes a second register storing the information about the number of clock delays.

### Advantageous Effects

According to the one or more of the above embodiments, when an image that forms a single line is printed, each of a plurality of ring electrodes or each group of the ring electrodes is driven at different times, thereby reducing an instant maximum current value. Therefore, it is possible to reduce a power specification of a direct printing type image forming device, reduce manufacturing costs, and reduce a space for a capacitor that is necessary to stabilize power of a drive chip disposed in an electrode control board formed in an image forming device, thereby realizing a small image forming body.

Furthermore, electrical interference between adjacent ring electrodes is reduced because of a printing pattern according to an order of operating a plurality of ring electrodes, and a printing error between adjacent dots is reduced. Thus, a printed image has a visually rectilinear shape, thereby preventing deterioration in printing quality.

### DESCRIPTION OF DRAWINGS

These and/or other aspects will become apparent and more readily appreciated from the following description of the embodiments, taken in conjunction with the accompanying drawings of which:

FIG. 1 illustrates a direct printing type image forming device according to an embodiment;

FIG. 2 is a perspective view of an image forming body shown in FIG. 1;

FIG. 3 is a block diagram of a controller included in the image forming device shown in FIG. 1;

FIG. 4 is a flowchart illustrating a printing method according to an embodiment;

FIG. 5 is a graph illustrating variations of an instant maximum current value when a plurality of ring electrodes simultaneously operate and operate at different times;

FIGS. 6A through 6C illustrate printing patterns according to a variety of operating modes of a plurality of ring electrodes with regard to a printing method according to an embodiment;

FIG. 7 illustrates gaps between adjacent dots when a plurality of ring electrodes are separated into 32 groups and the 32 groups operate according to the printing pattern shown in FIG. 6C; and

FIG. 8 is a table of the definition of first and second registers storing the number of groups and delay time information, and 8 bit serial control data of addresses and values of the first and second registers.

### BEST MODE

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. In the drawings, the thicknesses of layers and regions are exaggerated for clarity.

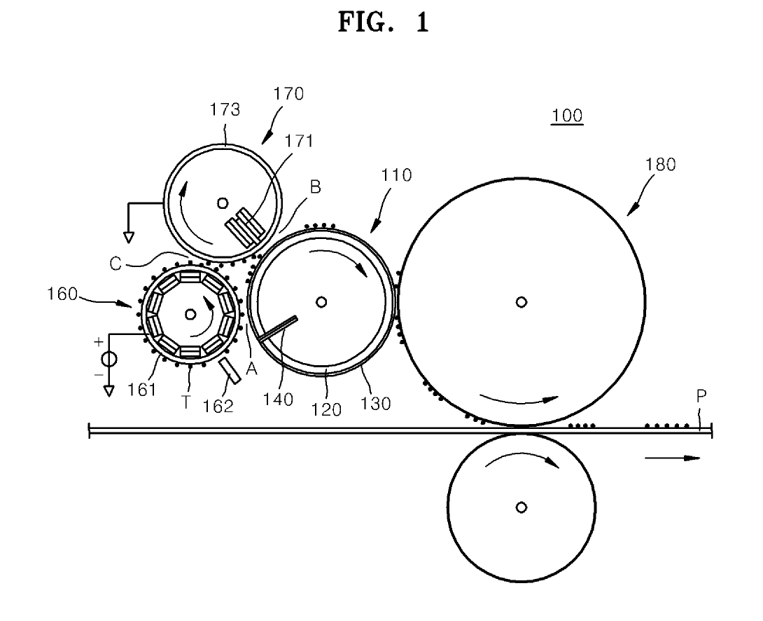

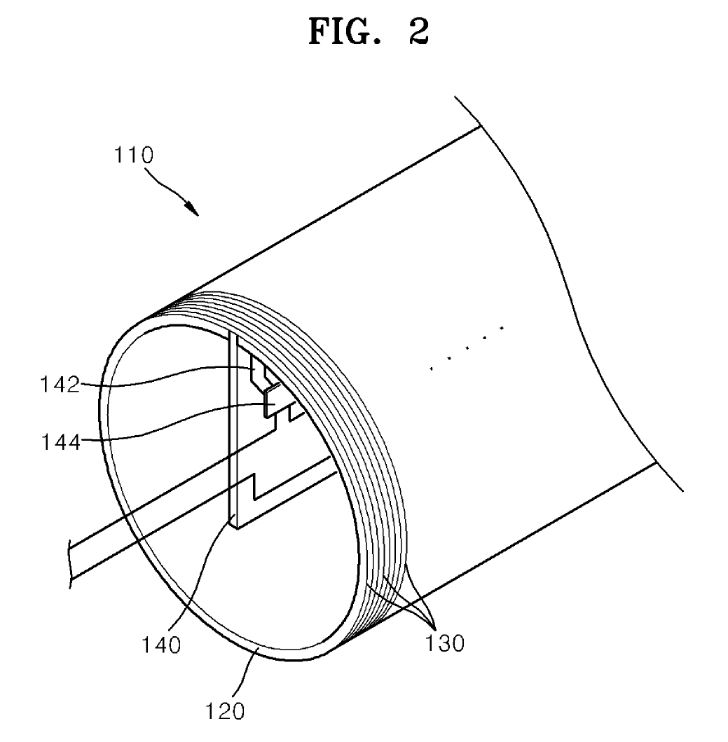

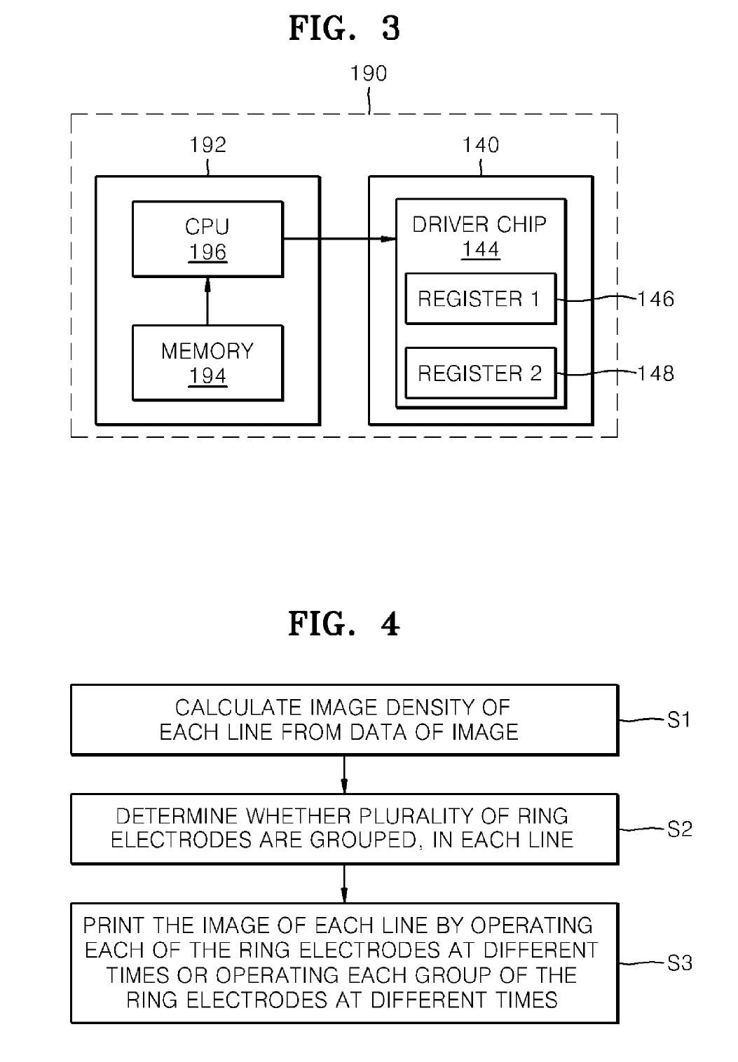

FIG. 1 illustrates a direct printing type image forming device 100 according to an embodiment. FIG. 2 is a perspective view of an image forming body 110 shown in FIG. 1. FIG. 3 is a block diagram of a controller 190 included in the image forming device 100 shown in FIG. 1.

Referring to FIGS. 1 through 3, the direct printing type image forming device 100 includes the image forming body 110, a toner supplying unit 160, a toner feedback unit 170, an image transferring unit 180, and the controller 190. The toner supplying unit 160, the toner feedback unit 170, and the image transferring unit 180 may be disposed around the image forming body 110.

The image forming body 110 may include a drum body 120 and a plurality of ring electrodes 130 disposed on the circumferential surface of the drum body 120. An electrode control board 140 may be installed in the drum body 120 and is included in the controller 190.

The drum body 120 has a hollow cylindrical shape, is rotatably installed, and is disposed near the toner supplying unit 160. The drum body 120 may be formed of a metal material such as aluminum or a non-metal insulator. If the drum body 120 is formed of the metal material such as aluminum, the circumferential surface of the drum body 120 may be oxidized to form an insulation capsule.

The ring electrodes 130 may be formed of a conductive metal such as copper and disposed on the circumferential surface of the drum body 120 at equal intervals in a lengthwise direction. The ring electrodes 130 are spaced apart from each other by a small gap so as to develop a high resolution image. For example, when an image having a resolution of 600 dpi is formed on an A4 printing medium P, about 4965 ring electrodes 130 are disposed on the surface of the image forming body 110, and a pitch between the 4965 ring electrodes 130 may be approximately 42.3 μm. The pitch between the ring electrodes 130 or the width of each of the ring electrodes 130 may vary according to a resolution of an image that is to be formed or the size of the printing medium P on which the image is formed.

The electrode control board 140 may include a circuit 142 coupled to each of the ring electrodes 130 and a driver chip 144 for controlling the ring electrodes 130. The driver chip 144 controls a voltage applied to each of the ring electrodes 130 via the circuit 142 according to a received image signal and group designation information of each line. This will be described in more detail later.

The toner supplying unit 160 supplies a toner T from a toner storage unit (not shown) to the image forming body 110 by using a toner supply roller 161. The toner T attached to the surface of the toner supply roller 161 is transferred from the toner supply roller 161 to the image forming body 110 through an adjacent area A between the toner supply roller 161 and the image forming body 110. A control unit 162 controls the amount of toner T attached to the surface of the toner supply roller 161. The toner T is electrified and magnetized. Due to an electrostatic attractive force induced by the voltage applied to each of the ring electrodes 130, the toner T is attracted by the image forming body 110. The toner T that is attached to the image forming body 110 is transferred to the toner feedback unit 170.

The toner feedback unit 170 may include a magnet cutter 171 providing a magnetic force and a rotation sleeve 173. The magnet cutter 171 is disposed in an adjacent area B between the toner feedback unit 170 and the image forming body 110, and attracts the toner T attached to the surface of the image forming body 110 due to the magnetic force. Since the toner T responds to the electrostatic attractive force of the image forming body 110 and the magnetic force of the magnet cutter 171, the toner T may be attached to the image forming body 110 or may be attracted by the magnet cutter 110 according to the relationship, in terms of intensity, between the electrostatic attractive force and the magnetic force.

The intensity of the electrostatic attractive force varies according to the amount of voltage applied to each of the ring electrodes 130 disposed in the image forming body 110. Thus, if the amount of voltage applied to one of the ring electrodes 130 is established to induce an electrostatic attractive force greater than the magnetic force of the magnet cutter 171, the toner T is attached to the ring electrode 130 to which the voltage is applied, due to the greater electrostatic attractive force, and although the toner T passes through the adjacent area B between the image forming body 110 and the toner feedback unit 170, the toner T may be continuously attached to the image forming body 110. Meanwhile, if the amount of voltage applied to one of the ring electrodes 130 is established to induce an electrostatic attractive force smaller than the magnetic force of the magnet cutter 171, the toner T is attached to the ring electrode 130 to which the voltage is applied, due to the smaller electrostatic attractive force, and when the toner T passes through the adjacent area B between the image forming body 110 and the toner feedback unit 170, the toner T is returned to the toner feedback unit 170 by the magnetic force of the magnet cutter 171. Therefore, the direct printing type image forming device 100 controls the voltage applied to each of the ring electrodes 130 according to an image signal, thereby forming an image corresponding to the image signal on the surface of the image forming body 110.

The toner T that is returned to the toner feedback unit 170 is transferred to the toner supplying unit 160 or the toner storage unit by the magnetic force at an adjacent area C between the rotation sleeve 173 and the toner supply roller 161.

The toner T that is not returned by the magnetic cutter 171 and is attached to the surface of the image forming body 110 is transferred from the image forming body 110 to the image transferring unit 180. The toner T transferred to the image transferring unit 180 is transferred to the printing medium P. The toner T transferred to the printing medium P is fixed to the printing medium P by a thermal treatment of the printing medium P, so that a desired image is formed.

Although the direct printing type image forming device 100 includes one of each of the image forming body 110, the toner supplying unit 160, and the toner feedback unit 170, the direct printing type image forming device 100 may include a plurality of the image forming bodies 110, the toner supplying units 160, and the toner feedback units 170 so as to form a color image. For example, a plurality of image forming bodies corresponding to the colors yellow Y, magenta M, cyan Cy, and black Bk may be disposed along the circumferential surface of the image supplying unit 180. Meanwhile, although the image supplying unit 180 is in the form of a roller, the present embodiment is not limited thereto. For example, the image supplying unit 180 may be in the form of a belt.

If an image of a single color is formed, the image may be transferred from the image forming body 110 to the printing medium P, without the image supplying unit 180.

The direct printing type image forming device 100 includes the controller 190. The controller 190 may include a main board 192 that is disposed in the direct printing type image forming device 100 and controls each element of the direct printing type image forming device 100 and an electrode control board 140 that is disposed in the drum body 120 of the image forming body 110 and controls the ring electrodes 130. The main board 192 may include a central processing unit (CPU) 196 and a memory 194. The electrode control board 140 may include the driver chip 144. The driver chip 144 may include a first register 146 and a second register 148 that store information transmitted from the CPU 196. This will be described in more detail later with reference to a printing method according to an embodiment.

Hereinafter, a printing method performed by the direct printing type image forming device 100 according to an embodiment will be described.

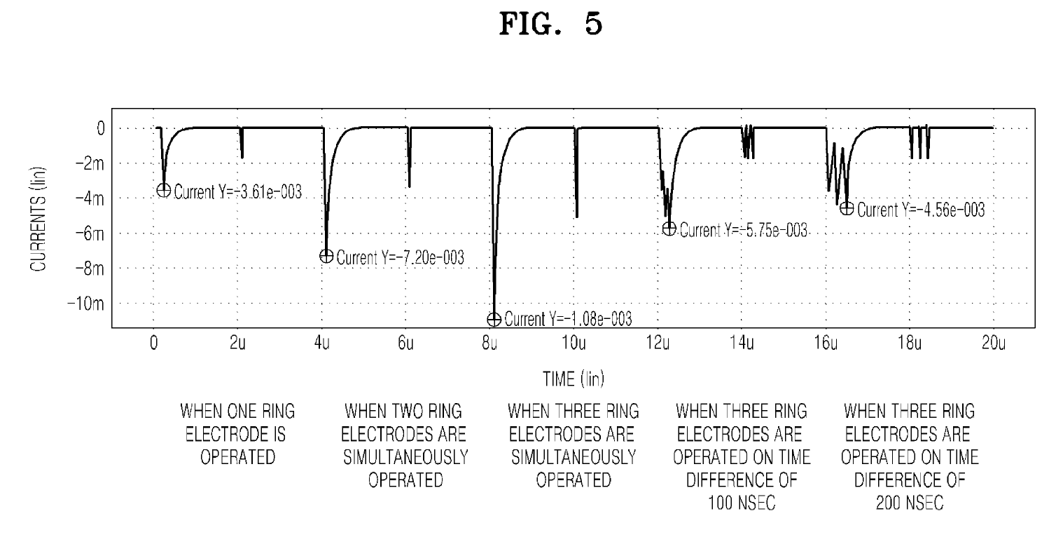

FIG. 4 is a flowchart illustrating a printing method according to an embodiment.

Referring to FIG. 4, the image density of each line is calculated from data of an image that is to be printed (operation S1). When the image is stored in a computer, the image data is transmitted from the computer to the direct printing type image forming device 100. When the image is stored in a portable electronic device, such as a digital camera, the image data may be directly input into the direct printing type image forming device 100, without the computer. Meanwhile, like a scanning or copying operation performed by the direct printing type image forming device 100, the direct printing type image forming device 100 may directly generate image data. The image data is stored in the memory 194 disposed in the main board 192 of the controller 190.

The image density of each line is calculated from the image data stored in the memory 194. Such a calculation may be performed by the CPU 196 of the controller 190. The image density refers to the number of printed dots among the number of entire dots of a single line extending in perpendicular to a moving direction of a printing paper, i.e., in a lengthwise direction of an image forming body, given as a percentage. For example, the image density of a solid line is 100%.

It is determined whether the plurality of ring electrodes 130 are grouped into at least one of groups according to the calculated image density in each line (operation S2). Operation S2 may be performed by the CPU 196 of the controller 190.

In more detail, it is determined whether each of the ring electrodes 130 operates or the plurality of ring electrodes 130 are grouped into at least one group in each line operates. When the ring electrodes 130 are grouped into at least one group, if the image forming body 110 includes 4965 ring electrodes 130, the 4965 ring electrodes 130 may be grouped into a single group or may be separated into a plurality of groups, for example, into 2, 4, 8, 12, 15, 25, and 32 groups. For example, when the 4965 ring electrodes 130 are separated into 12 groups, each of the 12 groups may include 414 ring electrodes 130, and when the 4965 ring electrodes 130 are separated into 32 groups, each of the 32 groups may include 155 ring electrodes 130.

If one of the lines has a high image density, for example, if the image density, like the solid line, is 100%, all of the ring electrodes 130 needs to be operated in order to print the image. In this case, each of the ring electrodes 130 may be operated or the ring electrodes 130 may be separated into as many groups as possible. Thus, the number of the ring electrodes 130 that simultaneously operate is reduced, so that an instant maximum current value is reduced. This will be described later in more detail.

However, if one of the lines has a low image density, a small number of the ring electrodes 130 operate in order to print the image. In this case, since the small number of ring electrodes 130 are simultaneously operated, the ring electrodes 130 may be grouped as a single group or may be separated into a smaller number of groups.

Meanwhile, if one of the lines has a middle image density, the ring electrodes 130 may be separated into an appropriate number of groups according to the image density.

The number of groups separated according to the image density may be appropriately determined according to the size, power consumption, printing speed, printing resolution, etc. of the direct printing type image forming device 100.

The image of each line is printed by operating each of the ring electrodes 130 at different times or operating each group of the ring electrodes 130 at different times (operation S3). Operation S3 may be performed by the driver chip 144 disposed in the electrode control board 140 of the controller 190.

In more detail, when it is determined that each of the ring electrodes 130 is operated in operation S2, each of the ring electrodes 130 is operated at different times in operation S3, and when it is determined that the ring electrodes 130 are grouped into at least one group in operation S2, the each group of the ring electrodes 130 operates at different times in operation S3, so that each line is printed. In this regard, the ring electrodes 130 included in the same group simultaneously operate.

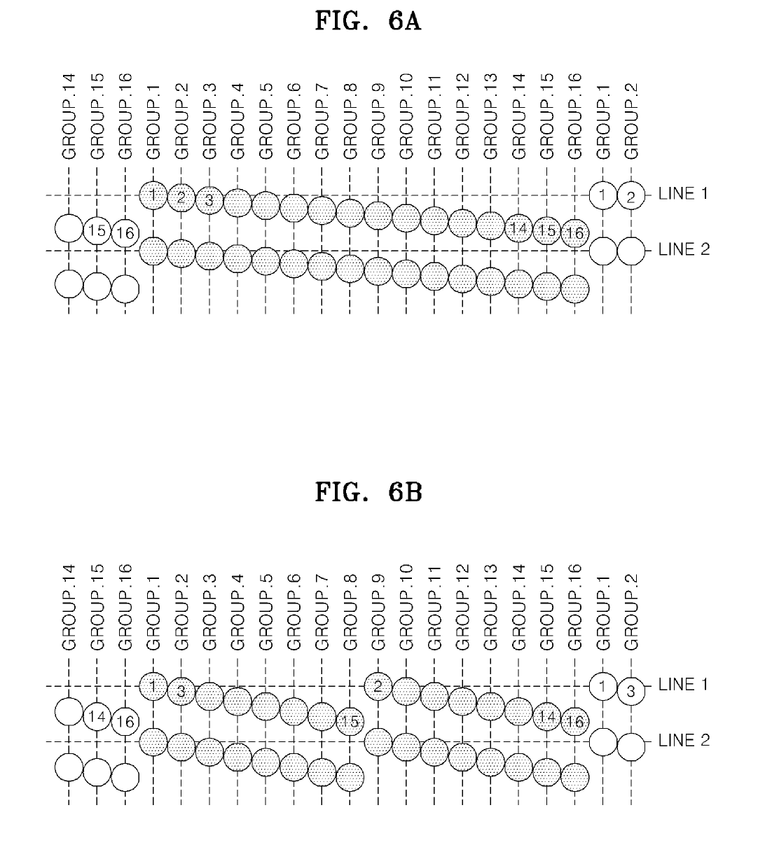

When each of the ring electrodes 130 is operated at different times or each group of the ring electrodes 130 operates at different times, the instant maximum current value is reduced. This will be described in more detail with reference to FIG. 5.

FIG. 5 is a graph illustrating variations of an instant maximum current value when the ring electrodes 130 simultaneously operate and operate at different times.

Referring to FIG. 5, the number of simultaneously operating ring electrodes 130 changes from 1 to 3, so that the instant maximum current value gradually increases.

Provided that each of the ring electrodes 130 disposed in the image forming body 110 has an electrical load of 10 pF, the instant maximum current value is proportional to the number of simultaneously operating ring electrodes 130. For example, when all 4965 ring electrodes 130 simultaneously operate, a maximum current value of about 18 A instantly flows.

However, as shown in the graph of FIG. 5, if each of the ring electrodes 130 operates at different times, the instant maximum current value may be reduced.

The printing method of the present embodiment operates each of the ring electrodes 130 or groups of the ring electrodes 130 at different times so as to print an image forming a single line, thereby reducing the instant maximum current value.

Therefore, the printing method of the present embodiment reduces the power specification and manufacturing costs of the direct printing type image forming device 100 and reduce a space for installing a capacitor used to stabilize power of the driver chip 144 that is a control unit of the image forming body 110, thereby realizing a small image forming body.

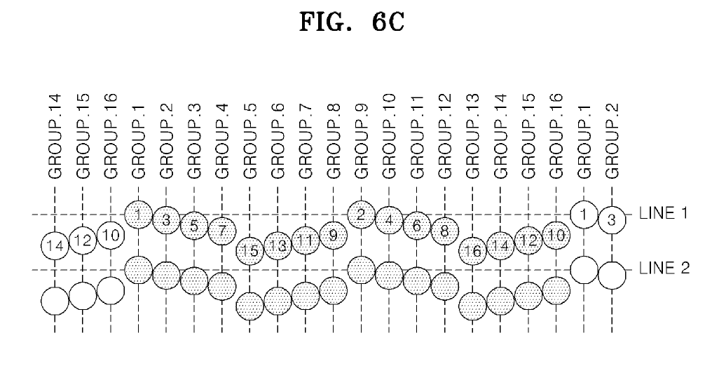

FIGS. 6A through 6C illustrate printing patterns according to a variety of operating modes of the ring electrodes 130 with regard to the printing method according to an embodiment.

Referring to 6A through 6C, the ring electrodes 130 are separated into 16 groups. When the ring electrodes 130 are numbered 1 through 4965 from one side, a first group includes 1^{st}, 17^{th}, 33^{rd}, . . . ring electrodes 130. A second group includes 2^{nd}, 18^{th}, 34^{th}, . . . ring electrodes 130. A sixteenth group includes 16^{th}, 32^{nd}, 48^{th}, . . . ring electrodes 130. That is, when the number of groups is n, the first group includes 1^{st}, n+1, 2n+1, 3n+1, . . . ring electrodes 130, the second group includes 2, n+2, 2n+2, . . . ring electrodes 130, and the sixteenth group includes 16^{th}, 16+n, 16+2n, . . . ring electrodes 130. When the number of groups is n, an m^{th} group includes m, n+m, 2n+m, . . . ring electrodes 130.

A plurality of small circles represent dots printed on printing paper according to the operation of the ring electrodes 130, and numbers included within the small circles are an operating order of the ring electrodes 130.

Although the printing patterns are formed when the ring electrodes 130 are separated into groups and each group operates at different times, the printing patterns are also applied when each of the ring electrodes operates at different times.

Referring to FIG. 6A, the printing pattern is formed when 16 groups of the ring electrodes 130 sequentially operate at different times. That is, the ring electrodes 130 of a first group operate, and after a predetermined period of time, the ring electrodes 130 of a second group operate. Thereafter, the ring electrodes 130 of a third group operate and thus the ring electrodes 130 of the 16 groups sequentially operate at different times. In this regard, the entire time difference between the first through sixteenth groups needs to be smaller than a time difference between a first line and a second line.

When a solid line is printed by using the method described above, the printing pattern includes a plurality of oblique lines each including 16 dots along printing lines as shown in FIG. 6A. If the ring electrodes 130 are separated into n groups, a printing pattern includes a plurality of oblique lines each including n dots along printing lines.

FIG. 6B illustrates a printing pattern where 16 groups of the ring electrodes 130 are separated into a former group (first through eighth groups) and a latter group (ninth through sixteenth groups), and the former and latter groups alternately operate at different times. That is, the ring electrodes 130 of the first group included in the former group operate, and after a predetermined period of time, the ring electrodes 130 of the ninth group included in the latter group operate. Thereafter, the ring electrodes 130 of the second group included in the former group operate and then the ring electrodes 130 of the tenth group included in the latter group operate so that the ring electrodes 130 of the sixteenth group operate at different times. In this regard, the entire time difference between the first through sixteenth groups needs to be smaller than a time difference between a first line and a second line.

When a solid line is printed by using the method described above, the printing pattern includes a plurality of oblique lines each including 8 dots that are half of the number of groups along printing lines as shown in FIG. 6B. If the ring electrodes 130 are separated into n groups, a printing pattern includes a plurality of oblique lines each including n/2 dots along printing lines. In the printing pattern shown in FIG. 6B, a time difference between dots included in the first group and dots included in the second group doubles compared to that of the printing pattern shown in FIG. 6A. In this case, an electrical interference generated by continuously operating adjacent ring electrodes may be reduced.

In the printing patterns shown in FIGS. 6A and 6B, dots printed by the ring electrodes 130 of the first group that first operates and dots printed by the ring electrodes 130 of the sixteenth group that finally operates are adjacent to each other, which incur gaps between the adjacent dots. The gaps, i.e. printing errors are very small, so that a user does not recognize the printing errors.

FIG. 6C illustrates the printing pattern where sixteen groups operate at different times, the sixteen groups are sequentially separated into four representative groups, groups included in the first representative group and groups included in the third representative group alternately operate, and groups included in the second representative group and groups included in the fourth representative group alternately operate. In this regard, the groups included in the second representative group and groups included in the fourth representative group operate in a reverse order. In more detail, the ring electrodes 130 of the first group included in the first representative group operate, and after a predetermined period of time, the ring electrodes 130 of the ninth group included in the third representative group operate. The ring electrodes 130 of the second group included in the first representative group operate, and after a predetermined period of time, the ring electrodes 130 of the tenth group included in the third representative group operate, and thus the ring electrodes 130 of the fourth group included in the first representative group operate, and after a predetermined period of time, the ring electrodes 130 of the twelfth group included in the third representative group operate. Thereafter, the ring electrodes 130 of the eighth group included in the second representative group operate, and after a predetermined period of time, the ring electrodes 130 of the sixteenth group included in the fourth representative group operate. Then, the ring electrodes 130 of the seventh group included in the second representative group operate, and after a predetermined period of time, the ring electrodes 130 of the fifteenth group included in the fourth representative group operate. The ring electrodes 130 of the fifth group included in the second representative group operate, and after a predetermined period of time, the ring electrodes 130 of the thirteenth group included in the fourth representative group operate.

When a solid line is printed by using the method described above, the printing pattern includes a plurality of zigzag oblique lines each including 4 dots along printing lines as shown in FIG. 6C. If the ring electrodes 130 are separated into n groups, a printing pattern includes a plurality of zigzag oblique lines each including n/4 dots along printing lines.

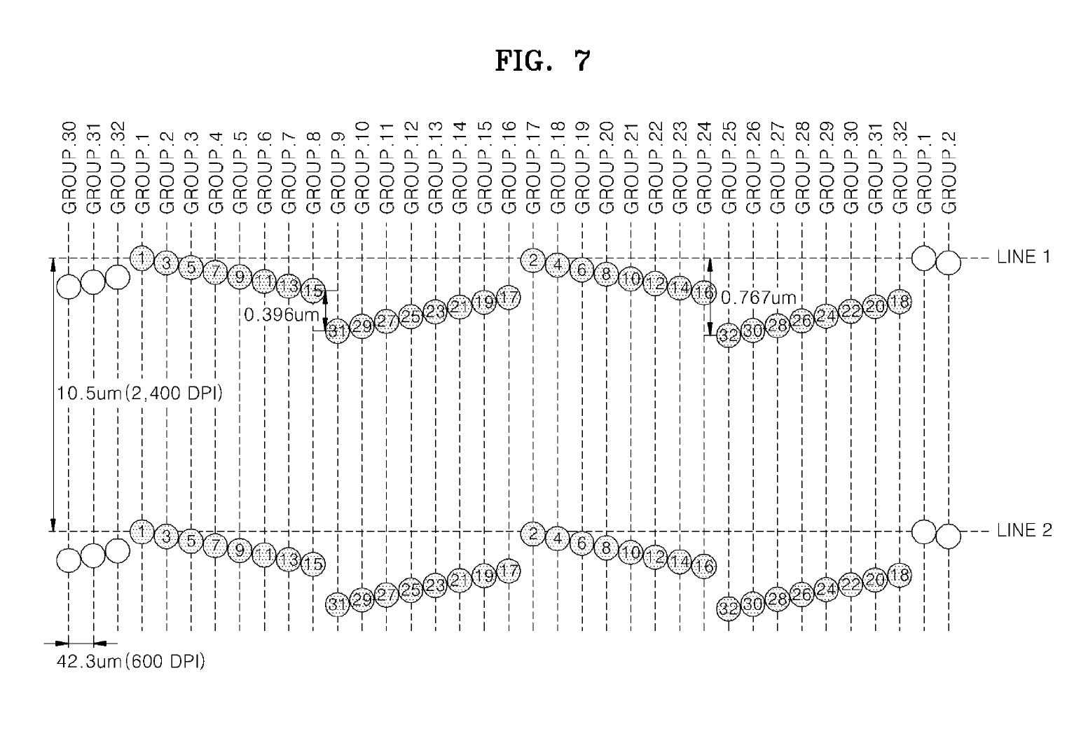

In the zigzag printing pattern shown in FIG. 6C, a time difference between adjacent dots doubles compared to that of the printing pattern shown in FIG. 6A and thus an electrical interference between the adjacent ring electrodes may be reduced in the same manner as shown in FIG. 6B. In particular, in the zigzag printing pattern, gaps between the adjacent dots, i.e. printing errors, may be reduced by half compared to the printing patterns shown in FIGS. 6A and 6B and have a visually rectilinear shape, thereby preventing deterioration of printing quality. This will be described in more detail with reference to FIG. 7.

FIG. 7 illustrates gaps between adjacent dots when the ring electrodes 130 are separated into 32 groups and the 32 groups operate according to the printing pattern shown in FIG. 6C.

Referring to FIG. 7, 155 of the 4965 ring electrodes 130 are included in a group and simultaneously operate. At this time, an instant maximum current value is 0.56 A that is reduced by 1/32 compared to 18 A when all the ring electrodes 130 simultaneously operate. Provided that an operating time difference (a time delay value) between the ring electrodes 130 is 200 nsec, a horizontal*vertical resolution is 600*2400 dpi, and a maximum printing speed is 25 ppm, a maximum printing error is 0.767 μm, a printing error between the adjacent dots is about 0.396 μm. The printing error is less than 1 μm and is considerably smaller than a gap between lines of 10.5 μm, so that users do not recognize the printing error.

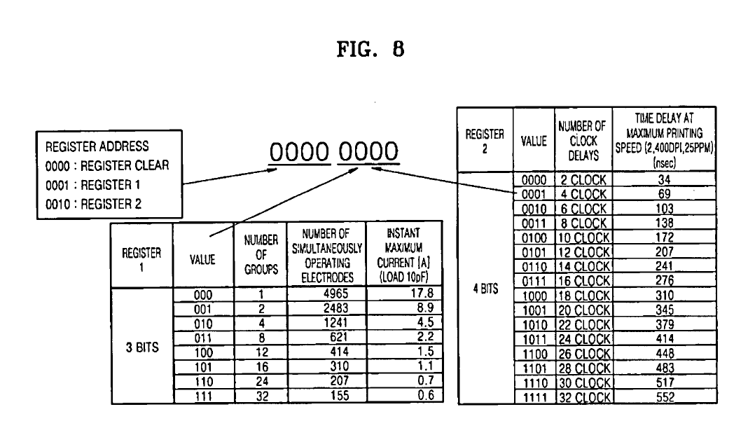

FIG. 8 is a table of the definition of first and second registers 146 and 148 storing the number of groups and delay time information, and 8 bit serial control data of addresses and values of the first and second registers 146 and 148.

When an image is printed, the image density of each line differs. When a line having a high image density is printed, an instant maximum current value may be reduced by increasing the number of groups, and when a line having a low image density is printed, a printing error may be reduced by reducing the number of groups. Therefore, a signal for designating the number of groups of each line and a delay time (time difference) is necessary.

In operation S2 of FIG. 4, the CPU 196 of the controller 190 shown in FIG. 3 determines whether to operate each of the ring electrodes 130 or to operate the ring electrodes 130 that are grouped into at least one group according to the image density of each line. The CPU 196 generates control data including the determined group designation information of each line and an image signal and transmits the generated control data and image signal to the driver chip 144 of the electrode control board 140. Referring to FIG. 8, the control data may be the 8 bit serial control data. The group designation information of each line is stored in the first register 146 of the driver chip 144. The driver chip 144 operates the ring electrodes 130 according to the group designation information of each line. The control data may include the number of clock delays corresponding to a determined delay time and may be stored in the second register 148. Meanwhile, when the direct printing type image forming device 100 maintains a constant maximum printing speed, the delay time has a predetermined value. In this case, the number of clock delays corresponding to the delay time may be previously stored as a predetermined default value. Thus, information corresponding to the second register 148 of each line may not be necessary.

As described above, according to the one or more of the above embodiments, when an image that forms a single line is printed, each of a plurality of ring electrodes or each group of the ring electrodes is driven at different times, thereby reducing an instant maximum current value. Therefore, it is possible to reduce a power specification of a direct printing type image forming device, reduce manufacturing costs, and reduce a space for a capacitor that is necessary to stabilize power of a drive chip disposed in an electrode control board formed in an image forming device, thereby realizing a small image forming body.

Furthermore, electrical interference between adjacent ring electrodes is reduced because of a printing pattern according to an order of operating a plurality of ring electrodes, and a printing error between adjacent dots is reduced. Thus, a printed image has a visually rectilinear shape, thereby preventing deterioration in printing quality.

It should be understood that the exemplary embodiments described therein should be considered in a descriptive sense only and not for purposes of limitation. Descriptions of features or aspects within each embodiment should typically be considered as available for other similar features or aspects in other embodiments.

1. A printing method that uses an image forming body including a plurality of electrodes, wherein at least one of the plurality of electrodes is operated with regard to an adjacent electrode at different times.

2. A printing method that uses an image forming body including a plurality of electrodes, wherein an image of a single line is printed by operating at least some of the plurality of electrodes at different times.

3. The printing method of claim 2, wherein each of the plurality of electrodes is operated at different times.

4. The printing method of claim 2, wherein the plurality of electrodes are grouped into at least one group and each group of the plurality of electrodes operates at different times.

5. The printing method of claim 2, wherein the plurality of electrodes are ring electrodes.

6. The printing method of claim 2, comprising:
calculating image density of each line from data of the image that is to be printed;
determining whether each of the plurality of electrodes is operated or the plurality of electrodes are grouped into at least one group according to the calculated image density in each line; and
printing the image of each line by operating each of the plurality of electrodes or each group of the plurality of electrodes at different times.

7. The printing method of claim 6, wherein, if it is determined that the plurality of electrodes are grouped into at least one group, the more the image density increases, the more the number of groups increases.

8. The printing method of claim 6, wherein, if it is determined that the plurality of electrodes are grouped into at least one group, the plurality of electrodes included in the same group are simultaneously operated.

9. The printing method of claim 6, wherein, if it is determined that the plurality of electrodes are grouped into a plurality of groups, the plurality of groups are sequentially numbered from one side of the plurality of electrodes, and, when it is determined that the plurality of electrodes are grouped into n groups, an m^{th} group includes m^{th}, n+m^{th}, 2n+m^{th}, . . . electrodes.

10. The printing method of claim 9, wherein, when it is determined that the plurality of electrodes are grouped into n groups, the n groups are sequentially operated at predetermined different times.

11. The printing method of claim 10, wherein the image is formed in a printing pattern including a plurality of oblique lines each including n dots along printing lines.

12. The printing method of claim 9, wherein, when it is determined that the plurality of electrodes are grouped into n groups, the n groups are divided into a former group and a latter group and are alternately operated at predetermined different times.

13. The printing method of claim 12, wherein the image is formed in a printing pattern including a plurality of oblique lines each including n/2 dots along printing lines.

14. The printing method of claim 9, wherein, when it is determined that the plurality of electrodes are grouped into n representative groups, groups included in the first representative group and groups included in the third representative group are alternately operated and then groups included in the second representative group and groups included in the fourth representative group alternately operate.

15. The printing method of claim 14, wherein the groups included in the second representative group and the groups included in the fourth representative group are alternately operated in a reverse order.

16. The printing method of claim 15, wherein the image is formed in a printing pattern including a plurality of zigzag oblique lines each including n/4 dots along printing lines.

17. The printing method of claim 6, wherein, when it is determined that the plurality of electrodes are grouped into a plurality of groups, the plurality of groups are sequentially numbered from one side of the plurality of electrodes and one of each groups is selectively operated.

18. The printing method of claim 17, wherein the electrode having the same number of each group is selectively operated.

19. The printing method of claim 6, wherein the calculating and the determining are performed by a central processing unit (CPU) of an image forming device and the operating of the plurality of electrodes is performed by a driver chip formed in the image forming body.

20. The printing method of claim 19, wherein group designation information generated by the CPU of the image forming device is 8 bit serial control data, is transmitted to the driver chip, and is stored in a first register of the driver chip.

21. The printing method of claim 20, wherein the 8 bit serial control data includes information about the number of clock delays corresponding to a determined time difference, and the information about the number of clock delays is stored in a second register of the driver chip.

22. An image forming device comprising:
an image forming body including a plurality of electrodes; and
a controller controlling to operate at least some of the plurality of electrodes at different times and print a single line image.

23. The image forming device of claim 22, wherein the controller comprises:
a memory storing the image that is to be printed;
a CPU calculating image density of each line from data of the image that is to be printed, determining whether each of the plurality of electrodes is operated or the plurality of electrodes are grouped into at least one group according to the calculated image density of each line, and generating control data including group designation information of each line and an image signal; and
a driver chip operating each of the plurality of electrodes or the each group of the plurality of electrodes at different times according to the control data and the image signal received from the CPU.

24. The image forming device of claim 23, wherein an electrode control board is installed in a drum body of the image forming body, and wherein the electrode control board comprises the driver chip and a circuit coupling the driver chip to each of the plurality of electrodes.

25. The image forming device of claim 23, wherein the control data is 8 bit serial control data that is transmitted from the CPU to the driver chip.

26. The image forming device of claim 23, wherein the driver chip includes a first register storing the group designation information of each line.

27. The image forming device of claim 26, wherein the control data further comprises information about the number of clock delays corresponding to a determined time difference, and the driver chip further includes a second register storing the information about the number of clock delays.
